(19) United States
(12) Patent Application Publication
(10) Pub. No.: US 2021/0209504 A1
(43) Pub. Date: Jul. 8, 2021

(54) LEARNING METHOD, LEARNING DEVICE, AND LEARNING PROGRAM

(71) Applicant: NIPPON TELEGRAPH AND TELEPHONE CORPORATION, Tokyo (JP)

(72) Inventors: Shingo ORIHARA, Musashino-shi, Tokyo (JP); Yo KANEMOTO, Musashino-shi, Tokyo (JP); Yuta IWAKI, Musashino-shi, Tokyo (JP); Kunio MIYAMOTO, Musashino-shi, Tokyo (JP); Yuichi MURATA, Musashino-shi, Tokyo (JP)

(73) Assignee: NIPPON TELEGRAPH AND TELEPHONE CORPORATION, Tokyo (JP)

(21) Appl. No.: 17/056,434

(22) PCT Filed: Apr. 19, 2019
(86) PCT No.: PCT/JP2019/016903

§ 371 Date: Nov. 18, 2020

(30) Foreign Application Priority Data
May 21, 2018 (JP) 2018-097452

(51) Int. Cl. G06N 20/00; G06F 21/55

(52) U.S. Cl. CPC G06N 20/00; G06F 2221/034; G06F 21/552

(57) ABSTRACT

A learning device generates a character class sequence abstracting a predetermined structure of a character string included in requests to a server. Also, the learning device saves an appearance frequency of each combination of predetermined identification information and character class sequence, which are included in requests for learning among the requests, as the profile. Also, the learning device collates combinations of predetermined identification information and character class sequence, which are included in requests for analysis among the requests, with the profile to detect abnormalities. Also, the learning device selects at least part of the requests, which are for analysis. Also, the learning device updates the profile based on the selected requests.

### FIELD

The present invention relates to a learning method, a learning device, and a learning program.

### BACKGROUND

As the Internet has become common, attacks on Web servers have been rapidly increasing. As countermeasures against the attacks, for example, an intrusion detection system (IDS), an intrusion prevention system (IPS), and a web application firewall (WAF) are known. In these techniques, detection is carried out with patterns using blacklists and signature files to carry out detection of and protection from known attacks.

Also, as a technique to detect unknown attacks, there is known a technique that learns profiles by using features extracted from predetermined values included in normal requests to a Web server to determine whether requests, which are analysis subjects, are attacks or not by using the profiles (for example, see Patent Literature 1).

### CITATION LIST

### Patent Literature

Patent Literature 1: WO 2015/186662 A

### SUMMARY

### Technical Problem

However, the conventional techniques have a problem that the learning of the profiles for detecting attacks may become insufficient. For example, in the technique described in Cited Literature 1, if a change of adding a path or a parameter to a Web application provided by a server is carried out, the learning following the change cannot be immediately carried out, and analysis is carried out with insufficiently learned profiles.

### Solution to Problem

To solve a problem and to achieve an object, a learning method executed by a computer, the learning method comprising: a generation process of generating a character class sequence abstracting a predetermined structure of a character string included in requests to a server; a save process of saving, as a profile, an appearance frequency of each combination of predetermined identification information and the character class sequence included in a request for learning among the requests; a detection process of collating, with the profile, a combination of the identification information and the character class sequence included in requests for analysis among the requests to detect an abnormality; a selection process of selecting at least part of the request for analysis; and an update process of updating the profile based on the request selected in the selection process.

### Advantageous Effects of Invention

According to the present invention, a profile for detecting attacks can be sufficiently learned.

### BRIEF DESCRIPTION OF DRAWINGS

FIG. 1 is a diagram illustrating an example of a configuration of a learning device according to a first embodiment.

FIG. 2 is a diagram for describing a learning processing and a detecting processing according to the first embodiment.

FIG. 3 is a diagram for describing a sequential learning processing according to the first embodiment.

FIG. 4 is a diagram for describing a sequential learning processing according to the first embodiment.

FIG. 5 is a diagram illustrating an example of a profile according to the first embodiment.

FIG. 6 is a diagram for describing a processing of generating character class sequence according to the first embodiment.

FIG. 7 is a diagram for describing a processing of updating the profile according to the first embodiment.

FIG. 8 is a flow chart illustrating a flow of a processing of the learning device according to the first embodiment.

FIG. 9 is a diagram illustrating an example of a configuration of a learning device according to a second embodiment.

FIG. 10 is a diagram for describing a sequential learning processing according to the second embodiment.

FIG. 11 is a diagram illustrating an example of a computer which executes the learning program according to the embodiment.

### DESCRIPTION OF EMBODIMENTS

Hereinafter, embodiments of a learning method, a learning device, and a learning program according to the present application will be described in detail based on drawings. Note that the present invention is not limited by the embodiments described below.

[Configuration of First Embodiment]

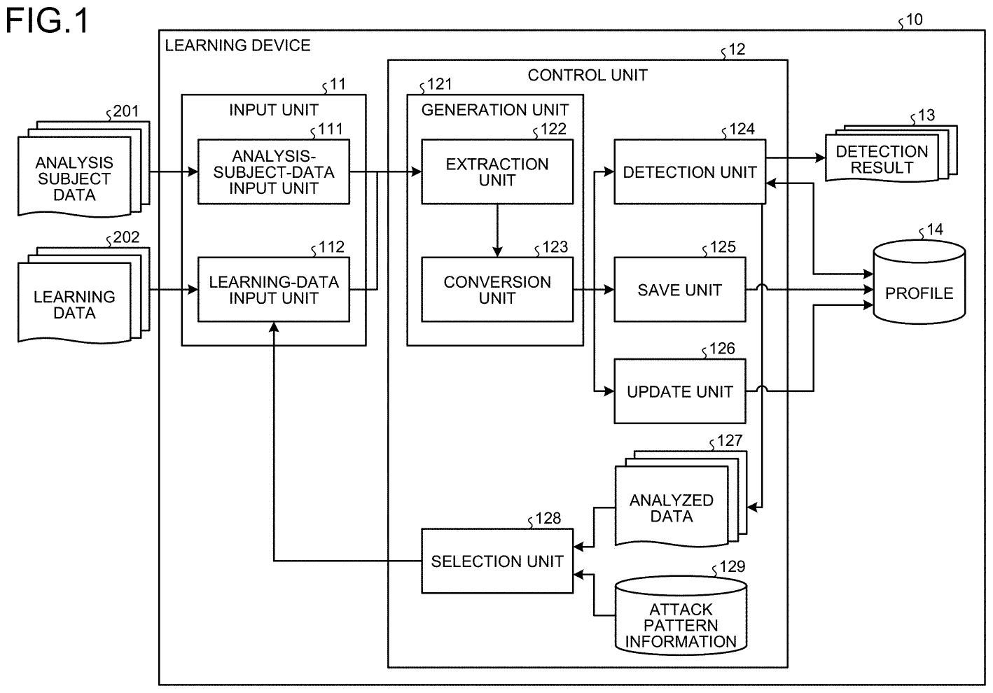

First, a configuration of a learning device according to a first embodiment will be described with reference to FIG. 1. FIG. 1 is a diagram illustrating an example of the configuration of the learning device according to the first embodiment. Based on similarity with requests to a server, a learning device 10 carries out learning of a profile 14, which is for determining whether the requests are attacks or not. Also, the learning device 10 detects requests, which are attacks, by using the profile 14. As illustrated in FIG. 1, the learning device 10 has an input unit 11 and a control unit 12 and stores detection results 13 and the profile 14.

The input unit 11 receives input of data for learning or analysis in the learning device 10. The input unit 11 has an analysis-subject-data input unit 111 and a learning-data input unit 112. The analysis-subject-data input unit 111 receives input of analysis subject data 201. Also, the learning-data input unit 112 receives input of learning data 202.

Herein, the analysis subject data 201 and the learning data 202 is, for example, HTTP requests generated in access to Web sites. Also, the learning data 202 may be HTTP requests which have already been found out to be attacks or not.

The control unit 12 has a generation unit 121, a detection unit 124, a save unit 125, and a selection unit 128. Also, the generation unit 121 has an extraction unit 122 and a conversion unit 123. Also, the control unit 12 has analyzed data 127 and attack pattern information 129.

The generation unit 121 generates a character class sequence abstracting a predetermined structure of a character string included in requests to the server. Herein, the request to the server is assumed to be an HTTP request. Hereinafter, a simple description, “request” is assumed to include a HTTP request. The generation unit 121 generates the character class sequence by processing in the extraction unit 122 and a conversion unit 123.

The extraction unit 122 extracts parameters from the analysis subject data 201 and the learning data 202 input to the input unit 11. Specifically, the extraction unit 122 extracts a path, keys of parameters, and values corresponding to the keys from each HTTP request.

For example, if the learning data 202 includes a URL “http://example.com/index.php?id=03&file=Top001.png”, the extraction unit 122 extracts “/index.php” as a path, extracts “id” and “file” as keys, and extracts “03” and “Top001.png” as the values corresponding to the keys.

Also, the conversion unit 123 converts the values, which have been extracted by the extraction unit 122, to a character class sequence. For example, the conversion unit 123 converts “03” and “Top001.png”, which are the values extracted by the extraction unit 122, to character class sequence.

The conversion unit 123 carries out the conversion to the character class sequence, for example, by replacing a part of the values including a number by “numeric”, replacing a part including an alphabet by “alpha”, and replacing a part including a symbol by “symbol”. The conversion unit 123 converts, for example, the value “03” to a character class sequence “(numeric)”. Also, the conversion unit 123 converts, for example, the value “Top001.png” to a character class sequence “(alpha, numeric, symbol, alpha)”.

The detection unit 124 collates combinations of predetermined identification information and character class sequence, which are included in the requests for analysis among requests, with the profile 14 to detect abnormalities. Also, in the present embodiment, the predetermined identification information is a combination of a path and a key extracted by the extraction unit 122.

Specifically, the detection unit 124 detects an attack, for example, by calculating the similarity between the profile 14 and the path, the key, and the character class sequence received from, for example, the conversion unit 123 and comparing the calculated similarity with a threshold value. For example, if the similarity between the profile 14 and the path, the key, and the character class sequence of certain analysis subject data 201 is equal to or less than the threshold value, the detection unit 124 detects the analysis subject data 201 as an attack. Also, the detection unit 124 outputs the detection results 13.

The save unit 125 saves the appearance frequency of each combination of the predetermined identification information and the character class sequence, which are included in the requests for learning among the requests, as the profile 14. Specifically, the save unit 125 saves the paths, the keys, and the character class sequence, which have been received from the conversion unit 123, as the profile 14. In this process, if a plurality of character class sequence corresponding to the path and the key are present, for example, the plurality of character class sequence are saved as the profile 14 together with appearance frequencies.

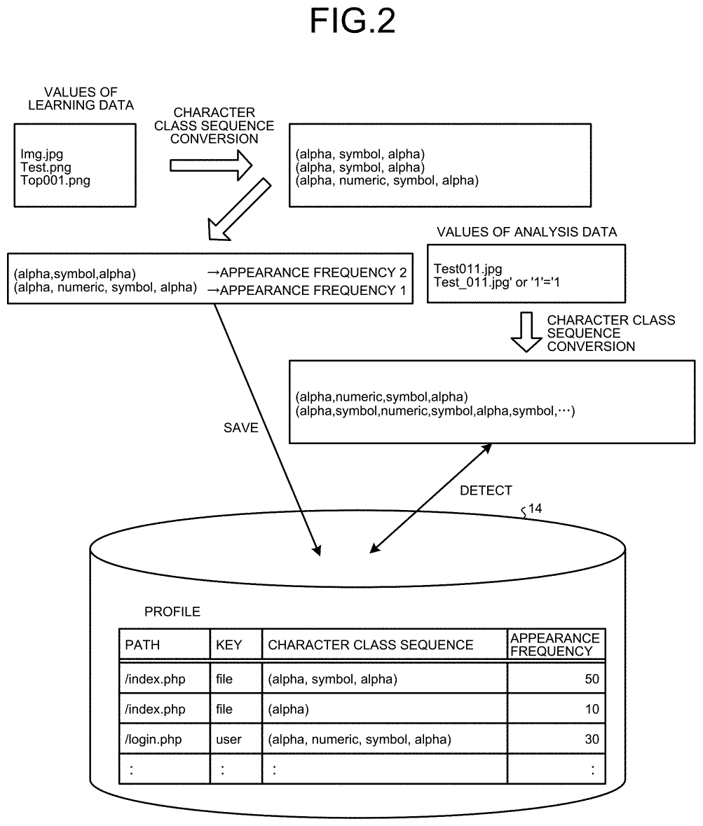

Herein, a learning processing and a detecting processing carried out by the learning device 10 will be described by using FIG. 2. FIG. 2 is a diagram for describing the learning processing and the detecting processing according to the first embodiment.

First, the learning data 202 is assumed to include URLs “http://example.com/index.php?file=Img.jpg”, “http://example.com/index.php?file=Test.png”, and “http://example.com/index.php?file=Top001.png”. Also, the analysis subject data 201 is assumed to include URLs “http://example.com/index.php?file=Test011.jpg” and “http://example.com/index.php?file=Test 011.jpg’ or ‘1’=‘1”.

In this process, the extraction unit 122 extracts values “Img.jpg”, “Test.png”, and “Top001.png” from the learning data 202. Also, the extraction unit 122 extracts values “Test011.jpg” and “Test 011.jpg’ or ‘1’=‘1’ from the analysis subject data 201.

Then, as illustrated in FIG. 2, the conversion unit 123 converts the values “Img.jpg”, “Test.png”, and “Top001.png” to character class sequence “(alpha, symbol, alpha)”, “(alpha, symbol, alpha)”, and “(alpha, numeric, symbol, alpha)”, respectively.

Also, the conversion unit 123 converts the values “Test011.jpg” and “Test 011.jpg’ or ‘1’=‘1’ to character class sequence “(alpha, numeric, symbol, alpha)” and “(alpha, symbol, numeric, symbol, alpha, symbol, space, alpha, space, symbol, numeric, symbol, numeric)”, respectively.

Herein, it is assumed that “alpha” is a character class representing all alphabetic characters, “numeric” is a character class representing all numbers, “symbol” is a character class representing all symbols, and “space” is a character class representing blank characters. It is assumed that the definitions of the character classes are provided in advance, and character classes other than alpha, numeric, symbol, and space showed here as examples may be defined.

Then, the detection unit 124 calculates the similarity between the profile 14 and the data of the combinations of paths and keys corresponding to the character class sequence “(alpha, numeric, symbol, alpha)” and “(alpha, symbol, numeric, symbol, alpha, symbol, space, alpha, space, symbol, numeric, symbol, numeric)”, which are from the analysis subject data 201, to detect an attack.

Also, the save unit 125 saves the combinations of the paths, keys, and character class sequence of the URLs, which are included in the learning data 202, in the profile 14 together with respective appearance frequencies thereof. For example, the save unit 125 saves (alpha, symbol, alpha) an appearance frequency 2, and (alpha, numeric, symbol, alpha) an appearance frequency 1 in the profile 14 together with the corresponding paths and keys.

Hereinabove, the learning processing and the detecting processing have been described. In the present embodiment, after the profile 14 is saved by the save unit 125, the profile 14 is further updated by an update unit 126. In this process, the update unit 126 updates the profile 14 by using at least part of the analysis subject data 201, which has been used in the detection by the detection unit 124. In the process, the analysis subject data 201 used to update the profile 14 is selected by the selection unit 128. Note that, in the description hereinafter, the update of the profile 14 by the update unit 126 may be referred to as sequential learning.

The selection unit 128 selects at least part of the requests, which are for analysis. Specifically, the selection unit 128 may select all of the analysis subject data 201, which has been used for the detection by the detection unit 124, or may select part thereof. Also, the analyzed data 127 is the analysis subject data 201 which has been used for the detection by the detection unit 124. Also, the selection unit 128 inputs the selected analyzed data 127 to the learning-data input unit 112.

The selection unit 128 can select the analysis subject data 201 by using an arbitrary method. Herein, as an example, a method of selection using the results of detection and a method of selection using attack patterns will be described.

(Method of Selection Using Results of Detection)

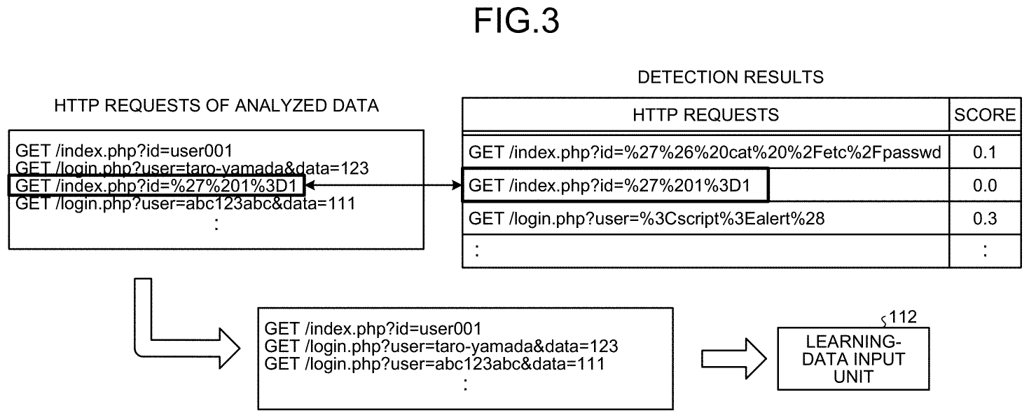

First, the method of selection using the results of detection will be described with reference to FIG. 3. FIG. 3 is a diagram for describing a sequential learning processing according to the first embodiment. In this case, the selection unit 128 selects a request, which has a degree of abnormality equal to or less than a predetermined value among the requests for analysis, based on the results of the detection by the detection unit 124.

Herein, it is assumed that the detection unit 124 calculates, in the detection, the score representing the degree of abnormality of each request. The score is within a range of 0.0 to 1.0, and it is assumed that the lower the score, the higher the degree of abnormality of the request becomes. It is assumed that the detection unit 124 causes the requests having the score of 0.3 or less to be included in the detection result 13. In other words, the detection results 13 include the requests which are considered to have high degrees of abnormality.

In the example of FIG. 3, the detection unit 124 calculates 0.0 as the score of a HTTP request “GET /index.php?id=%27%201%3D1” of the analyzed data 127.

Herein, the selection unit 128 compares the analyzed data 127 with the detection results 13 and excludes matching ones. In other words, the selection unit 128 selects the data in the analyzed data 127 that is not included in the detection results 13.

Note that the selection unit 128 may exclude the data in the analyzed data 127 that has the score of the detection results 13 less than a certain threshold value. As a result, only the data strongly suspected as an attack can be excluded from the subject of sequential learning.

(Method of Selection Using Attack Patterns)

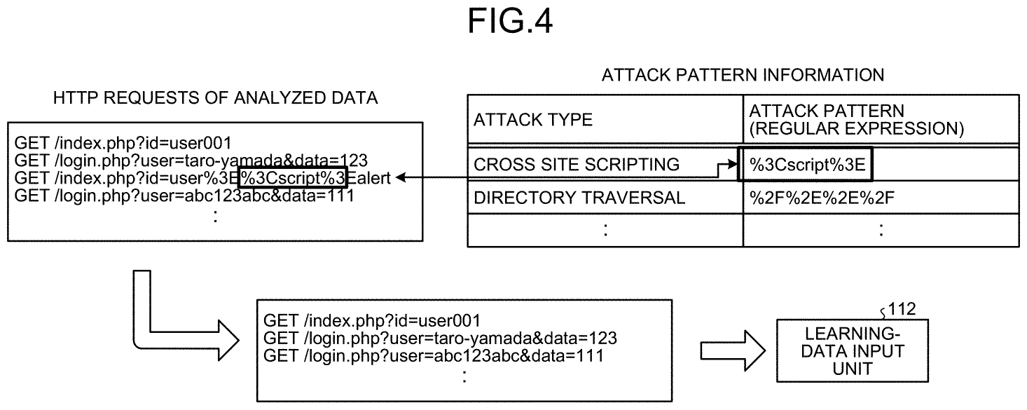

Next, the method of selection using attack patterns will be described by using FIG. 4. FIG. 4 is a diagram for describing a sequential learning processing according to the first embodiment. In this case, the selection unit 128 selects the requests which do not match predetermined patterns, which are set in advance, among the requests for analysis.

In the example of FIG. 4, it is assumed that the attack pattern information 129 is set in advance. In the attack pattern information 129, regular expressions of character strings, which appear in requests, are stored as the attack patterns for respective types of known attacks. The selection unit 128 excludes the requests which match the attack pattern information 129 among the requests of the analyzed data 127. In other words, the selection unit 128 selects the requests which do not match the attack pattern information 129 among the analyzed data 127.

Note that the attack pattern information 129 may be typical attack examples created by using information on the Web or signatures of a commercially-available web application firewall (WAF) as reference or may be created based on the detection result 13.

The update unit 126 updates the profile 14 based on the requests selected by the selection unit 128. The update of the profile 14 in sequential learning is carried out by using character class sequence generated from requests like the saving of the profile 14.

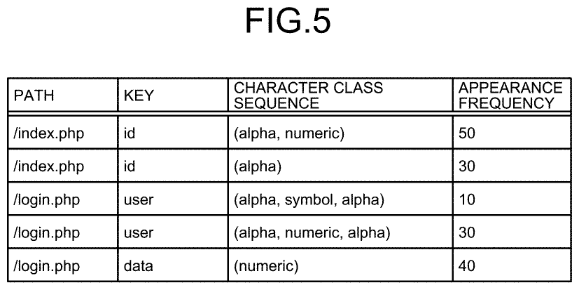

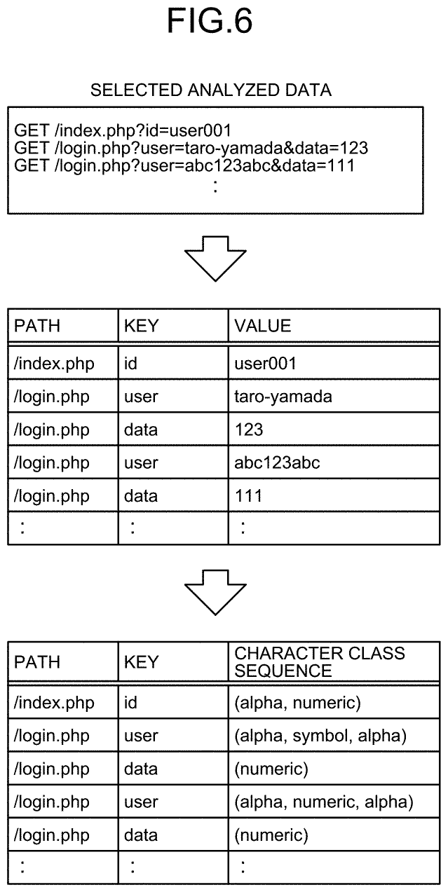

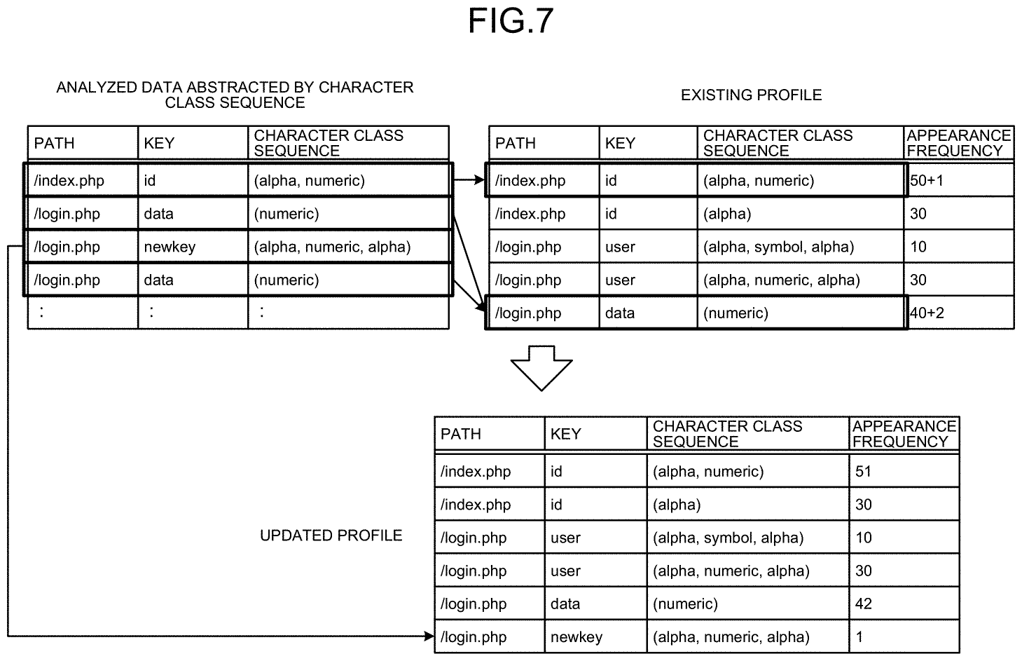

Herein, update of the profile will be described by using FIG. 5 to FIG. 7. FIG. 5 is a diagram illustrating an example of the profile according to the first embodiment. FIG. 6 is a diagram for describing a processing of generating character class sequence according to the first embodiment. FIG. 7 is a diagram for describing a processing of updating the profile according to the first embodiment.

First, as illustrated in FIG. 5, the profile 14 includes paths, keys, character class sequence, and appearance frequencies. Herein, each row of the profile 14, in other words, the combination of the path, the key, and the character class sequence will be referred to as a field.

The appearance frequencies of the profile 14 are the appearance frequencies of the respective fields in the learning processing. For example, in the learning processing of FIG. 2, the appearance frequency of the field having a path “/index.php”, a key “file”, and a character class sequence “(alpha, symbol, alpha)” is increased.

As illustrated in FIG. 6, the generation unit 121 parses the HTTP requests of the analyzed data 127, which have been selected by the selection unit 128 and input to the learning-data input unit 112, into paths, keys, and values and generates character class sequence from the values.

Then, as illustrated in FIG. 7, the update unit 126 increases the appearance frequency of the field, which matches the combination of the path, the key, and the character class sequence generated by the generation unit 121, by the number of the combination(s). Also, if the field that matches the combination of the path, the key, and the character class sequence generated by the generation unit 121 is not present in the profile 14, the update unit 126 adds this combination to the profile 14 as a new field.

[Processing of First Embodiment]

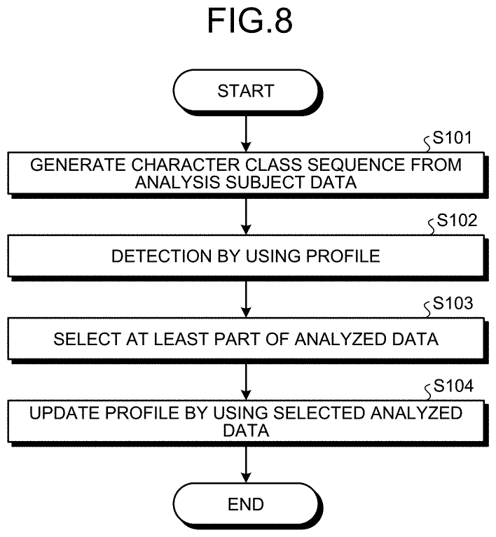

The flow of the processing of the learning device 10 will be described by using FIG. 8. FIG. 8 is a flow chart illustrating the flow of the processing of the learning device according to the first embodiment. As illustrated in FIG. 8, first, the learning device 10 generates character class sequence from the analysis subject data 201 (step S101). Then, the learning device 10 detects abnormality based on the generated character class sequence by using the profile 14 (step S102).

Then, the learning device 10 analyzes and selects at least part of the analyzed data 127 which has been used in the detection (step S103). Then, the learning device 10 updates the profile 14 by using the selected analyzed data 127 (step S104).

[Effects of First Embodiment]

The learning device 10 generates a character class sequence abstracting a predetermined structure of a character string included in requests to the server. Also, the learning device 10 saves the appearance frequency of each combination of the predetermined identification information and the character class sequence, which are included in the requests for learning among the requests, as the profile 14. Also, the learning device 10 collates combinations of predetermined identification information and character class sequence, which are included in the requests for analysis among requests, with the profile 14 to detect abnormalities. Also, the learning device 10 selects at least part of the requests, which are for analysis. Also, the learning device 10 updates the profile 14 based on the selected requests.

Since the profile is updated by using the analyzed data in this manner, changes in paths and/or parameters caused, for example, by specification changes of an analysis subject service can be followed. Also, even if initial learning is insufficient, the profile can be repeatedly updated, and precision of analysis is therefore improved during operation. Therefore, according to the present embodiment, the profile for detecting attacks can be sufficiently learned.

The learning device 10 can select a request, which has a degree of abnormality equal to or less than a predetermined value among the requests for analysis, based on the results of detection. By virtue of this, the analysis data suspected to be abnormal can be excluded from the subject of sequential learning. Therefore, abnormal data can be prevented from being learned as normal data.

The selection unit 128 can select the requests which do not match predetermined patterns, which are set in advance, among the requests for analysis. By virtue of this, analysis data known to be abnormal can be excluded from the subject of sequential learning. Therefore, abnormal data can be prevented from being learned as normal data.

### Second Embodiment

In the first embodiment, regardless of whether the parameters of the analyzed data 127 have been learned or not, the learning device 10 have selected the data which serves as the subject of sequential learning from the analyzed data 127 based on the predetermined rules. On the other hand, in a second embodiment, the learning device 10 selects the analyzed data 127 which have unlearned parameters as the subject of sequential learning.

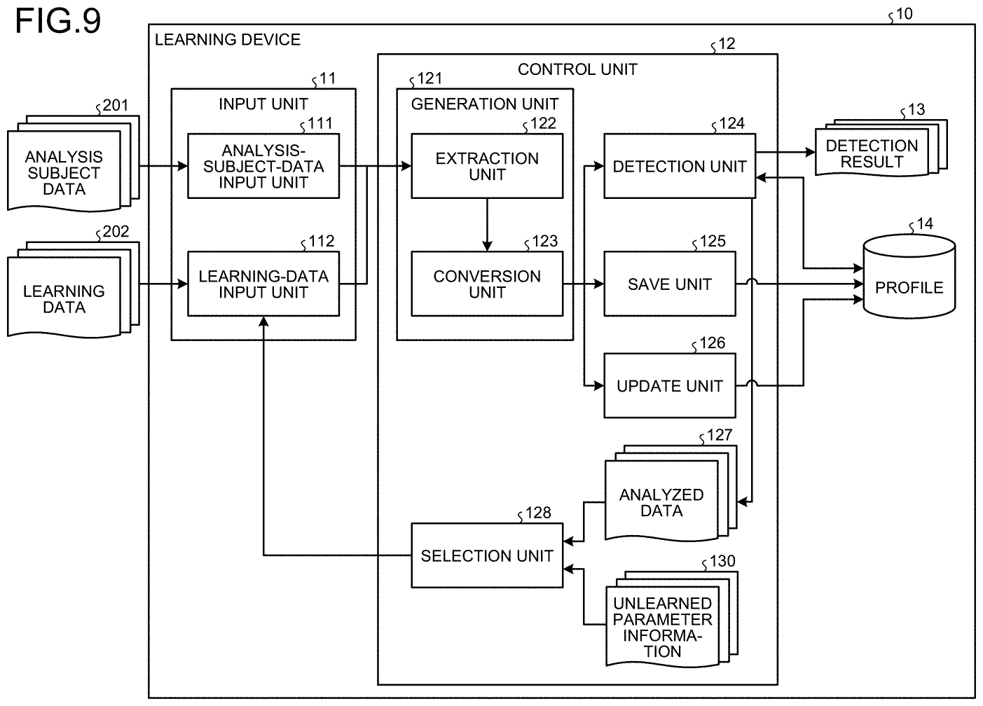

FIG. 9 is a diagram illustrating an example of a configuration of a learning device according to the second embodiment. As illustrated in FIG. 9, in the second embodiment, the learning device 10 has unlearned parameter information 130. Note that, in the second embodiment, the components which are similar to those of the first embodiment are denoted by the same reference signs, and description thereof will be omitted.

The unlearned parameter information 130 is identification information not included in the profile 14 and is generated, for example, when the converted analysis subject data and the profile are compared with each other in the detection unit 124. Herein, the identification information is a combination of a path and a key of a request. In this case, the detection unit 124 can add the combinations, which are not included in the profile 14 among the combinations of the paths and the keys of the requests of the analysis subject, to the unlearned parameter information 130 when detection is carried out. Therefore, the selection unit 128 selects the requests having the identification information not included in the profile 14 among the requests for analysis. By virtue of this, the profile 14 can be efficiently updated.

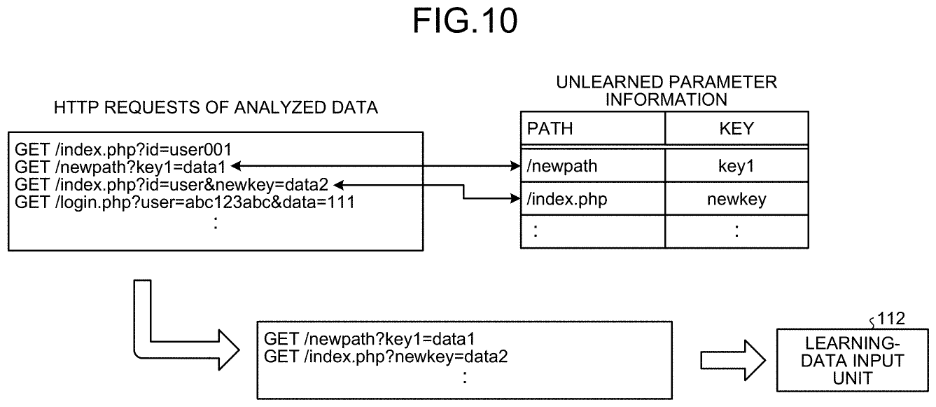

The selection unit 128 selects the data of the analyzed data 127 that has the identification information matching the unlearned parameter information 130. FIG. 10 is a diagram for describing a sequential learning processing according to the second embodiment. In the example of FIG. 10, identification information of a HTTP request “GET /newpath?key1=data1” is “/newpath” and “key1”. Herein, since the combination of “/newpath” and “key1” is present in the unlearned parameter information 130, the selection unit 128 selects the HTTP request “GET /newpath?key1=data1” as a subject of sequential learning.

Note that the selection unit 128 may immediately select the data having the identification information matching the unlearned parameter information 130 or may refer to, upon selection, the unlearned parameter information 130 which has the number of times of matching in a certain period of time equal to or higher than a threshold value. By virtue of this, for example, unlearned parameters temporarily generated due to, for example, erroneous input by a user can be ignored.

### Other Embodiments

Note that, in the embodiments, the profile 14 is shown in a tabular format. However, as the data storage format of the profile 14, the data may be stored by using a Javascript (registered trademark) object notation (JSON) format or a database of MySQL, PostgreSQL, or the like other than the tabular format. Also, all of the analysis subject data 201, the learning data 202, and the analyzed data 127 is the data including a plurality of HTTP requests and, for example, may be data in a JSON format of access logs or parsed or converted access logs of a Web server.

Also, the described methods of selecting data of the sequential learning subject by the selection unit 128 may be independently used or may be used in an appropriate combination. For example, the selection unit 128 can select the request which has a degree of abnormality equal to or less than a predetermined value and does not match the attack pattern information 129. Also, for example, the selection unit 128 can select the request which does not match the attack pattern information 129 and matches the unlearned parameter information 130.

[Program]

As an embodiment, the learning device 10 can be implemented by installing a learning program serving as packaged software or online software, which executes the above described learning, in a desired computer. For example, an information processing device can be caused to function as the learning device 10 by executing the above described learning program by the information processing device. The information processing device referred to herein includes a personal computer of a desktop type or a laptop type. Also, other than that, for example, smartphones, mobile communication terminals such as portable phones and personal handyphone systems (PHSs), and slate terminals such as personal digital assistants (PDAs) fall within the category of the information processing device.

Also, the learning device 10 can be implemented as a learning server device which uses a terminal device used by a user as a client and provides a service, which is related to the above described learning, to the client. For example, the learning server device is implemented as a server device providing a learning service which uses a profile before update and analysis subject HTTP requests as inputs and uses an updated profile as an output. In this case, the learning server device may be implemented as a Web server or a cloud which provides a service related to the above described learning by outsourcing.

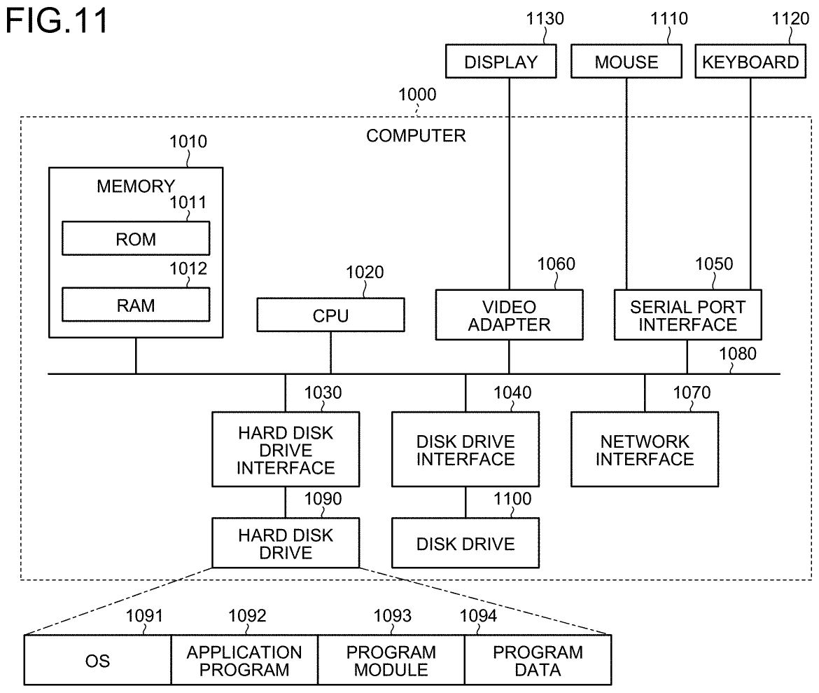

FIG. 11 is a diagram illustrating an example of a computer which executes the learning program according to the embodiment. A computer 1000 has, for example, a memory 1010 and a CPU 1020. Also, the computer 1000 has a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program of, for example, basic input output system (BIOS). The hard disk drive interface 1030 is connected to a hard disk drive 1090. The disk drive interface 1040 is connected to a disk drive 1100.

For example, an attachable/detachable storage medium such as a magnetic disk or an optical disk is inserted in the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. More specifically, the program which defines the processings of the learning device 10 is implemented as the program module 1093, in which codes executable by a computer are described. The program module 1093 is stored, for example, in the hard disk drive 1090. For example, the program module 1093 for executing the processings which are similar to the functional configuration of the learning device 10 is stored in the hard disk drive 1090. Note that the hard disk drive 1090 may be replaced by an SSD.

Also, setting data used in the processings of the above described embodiments is stored as the program data 1094, for example, in the memory 1010 or in the hard disk drive 1090. Then, in accordance with needs, the CPU 1020 reads the program module 1093 and/or the program data 1094, which is stored in the memory 1010 or the hard disk drive 1090, to the RAM 1012 and executes that.

Note that the program module 1093 and the program data 1094 is not limited to be stored in the hard disk drive 1090, but may be stored, for example, in an attachable/detachable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read from the other computer by the CPU 1020 via the network interface 1070.

### REFERENCE SIGNS LIST

10 LEARNING DEVICE

11 INPUT UNIT

12 CONTROL UNIT

13 DETECTION RESULT

14 PROFILE

111 ANALYSIS-SUBJECT-DATA INPUT UNIT

112 LEARNING-DATA INPUT UNIT

121 GENERATION UNIT

122 EXTRACTION UNIT

123 CONVERSION UNIT

124 DETECTION UNIT

125 SAVE UNIT

126 UPDATE UNIT

127 ANALYZED DATA

128 SELECTION UNIT

129 ATTACK PATTERN INFORMATION

130 UNLEARNED PARAMETER INFORMATION

201 ANALYSIS SUBJECT DATA

202 LEARNING DATA

1. A learning method executed by a computer, the learning method comprising:
generating a character class sequence abstracting a predetermined structure of a character string included in requests to a server;
saving, as a profile, an appearance frequency of each combination of predetermined identification information and the character class sequence included in a request for learning among the requests;
collating, with the profile, a combination of the identification information and the character class sequence included in requests for analysis among the requests for detecting an abnormality;
selecting at least part of the request for analysis; and
updating the profile based on the request selected in the selecting.

2. The learning method according to claim 1, wherein, in the selecting, a request having a degree of abnormality equal to or less than a predetermined value among the requests for analysis is selected based on a result of the detection in the detecting.

3. The learning method according to claim 1, wherein, in the selecting, a request not matching a predetermined pattern set in advance among the requests for analysis is selected.

4. The learning method according to claim 1, wherein, in the selecting, a request having the identification information not included in the profile among the requests for analysis is selected.

5. A learning device comprising: a memory; and a processor coupled to the memory and programmed to execute a process comprising:
generating a character class sequence abstracting a predetermined structure of a character string included in requests to a server;
saving, as a profile, an appearance frequency of each combination of predetermined identification information and the character class sequence included in a request for learning among the requests;
collating, with the profile, a combination of the identification information and the character class sequence included in requests for analysis among the requests to detect an abnormality;
selecting at least part of the request for analysis; and
updating the profile based on the request selected by the selecting.

6. A non-transitory computer-readable recording medium having stored therein a program, for learning, that causes a computer to execute a process, comprising:
generating a character class sequence abstracting a predetermined structure of a character string included in requests to a server;
saving, as a profile, an appearance frequency of each combination of predetermined identification information and the character class sequence included in a request for learning among the requests;
collating, with the profile, a combination of the identification information and the character class sequence included in requests for analysis among the requests to detect an abnormality;
selecting at least part of the request for analysis; and
updating the profile based on the request selected in the selecting.
